(19) United States
(12) Patent Application Publication
(10) Pub. No.: US 2023/0344359 A1
(43) Pub. Date: Oct. 26, 2023

(54) AC-To-DC Power Supplies, Control Methods, and Power Controllers with Functions of PFC and Output Voltage Regulation

(71) Applicant: Wen-Chung YEH, Taipei City (TW)

(72) Inventor: Wen-Chung YEH, Taipei City (TW)

(21) Appl. No.: 18/183,298

(22) Filed: Mar. 14, 2023

(30) Foreign Application Priority Data
Apr. 21, 2022 (TW) 111115297

(51) Int. Cl. H02M 3/335; H02M 1/00; H02M 1/42

(52) U.S. Cl. CPC H02M 3/33576; H02M 1/0035; H02M 1/0009; H02M 1/4258

(57) ABSTRACT

An AC-to-DC power supply converts an input power source into an output power source, capable of having a single stage to achieve PFC and output regulation at the same time. The AC-to-DC power supply has an inductive device, a main switch, a backup circuit providing a backup power, and a power controller. The power controller controls the main switch and the backup circuit to generate a power transfer cycle with an input slot, an internal-burst slot, and a demagnetization time. During the input slot, the power controller turns ON the main switch, so the input power source supplies power to increase electromagnetic energy of the inductive device. During the internal-burst slot, the backup power supplies power to the inductive device. During the demagnetization time, the electromagnetic energy releases to supply power to the output power source or the backup power.

### CROSS-REFERENCE TO RELATED APPLICATION

This application claims priority to and the benefit of Taiwan Application Series Number 111115297 filed on Apr. 21, 2022, which is incorporated here by reference in its entirety.

### BACKGROUND

The present disclosure relates generally to AC-to-DC power supplies, and more particularly to AC-to-DC power supplies with power factor correction (PFC).

It is commonly required by regulations that an AC-to-DC power converter outputting power of more than 65 watts has a power factor (PF) not less than a predetermined level, 0.9 for example. A power supply with PF close to 1, the idea number, means the current the power supply drains and the voltage the power supply receives are substantially in phase or proportional to each other. Equivalently speaking, it acts like a pure resistor.

Nevertheless, as a result, the amount of power that a power supply with good PF drains from a power source depends on the voltage of the power source, substantially proportional to the square of that voltage. For example, if an AC-to-DC power supply with good PF drains 100 W when receiving an input voltage of 100V, it will inevitably drain only 1 W when receiving an input voltage of 10V. Therefore, input power for that AC-to-DC power supply with good PF varies significantly, regardless of what the AC-to-DC power supply supplies power to. As a result, an AC-to-DC power supply needs specific technology to process the input power, to supply a load that might request constant or variable power.

A two-stage, cascade structure is commonly adopted for AC-to-DC power supplies to achieve high PF. The first stage is a PFC converter, providing a resistor-like input impedance for an AC-to-DC power supply. The second stage is an output regulator, filtering out the influence caused by 50 Hz or 60 Hz of an AC mains power and at the same time regulating the output voltage or current of the power supply. For example, the first stage is a booster, and the second one is a flyback converter or an LLC resonant converter. The output voltage of the first stage, which is also the input voltage of the second stage, might change significantly in comparison with the substantially constant output voltage that the second stage provides, substantially due to the fluctuation of the input power to the first stage. U.S. patent Ser. No. 10/148,169 is not an exception, having two stages: the first stage is a flyback providing galvanic isolation, and the second is a buck converter regulating the output.

The two-stage, cascade structure induces some disadvantages. First, the power conversion efficiency suffers because each stage contributes at least a certain amount of power conversion loss. Second, high product size and cost are inevitable because each stage needs several devices including at least a transformer or an inductor which is bulky and expensive. Since the market of power supplies tends to welcome products with high power and compact size, improvement or modification should be necessary to the two-stage, cascade structure.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 demonstrates an AC-to-DC power supply according to embodiments of the invention.

FIG. 2 demonstrates how AC-to-DC power supply 100 achieves both PFC and output regulation at the same time when the absolute voltage value of AC mains power VAC supplied from a wall socket is about 100V.

FIG. 3A-3C demonstrate current loops LOOP-E1, LOOP-DE1 and loop-DE2, respectively.

FIG. 4 demonstrates how AC-to-DC power supply 100 achieves both PFC and output regulation at the same time when the absolute voltage value of AC mains power is about 10V.

FIG. 5 demonstrates current loop LOOP-E2;

FIGS. 6A and 6B show switch statuses and waveforms indicating that AC-to-DC power supply 100 operates in CCM.

FIG. 7 demonstrates a primary-side controller and a secondary-side controller;

FIG. 8 demonstrates power transfer cycle TCYC5.

FIG. 9 demonstrates AC-to-DC bridgeless power supply 600 according to embodiments of the invention.

FIG. 10 demonstrates power transfer cycle TCYCP during a positive half period.

FIGS. 11A-11D demonstrate current loops LOOP-DP, LOOP-MP, LOOP-DOP, and LOOP-CP, respectively.

FIG. 12 demonstrates power transfer cycle TCYCN during a negative half period.

FIGS. 13A-13D demonstrate current loops LOOP-DN, LOOP-MN, LOOP-DON, and LOOP-CN, respectively.

FIG. 14 demonstrates AC-to-DC power supply 800 according to embodiments of the invention.

FIG. 15 demonstrates power transfer cycle TCYCB.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure, or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures, or characteristics may be combined in any suitable combinations and/or subcombinations in one or more embodiments or examples. Particular features, structures, or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

Embodiments include two flyback power converters with the function of PFC, one having a bridge rectifier and the other being bridgeless. Each of them has only one stage to achieve PFC and output regulation at the same time. Nevertheless, this invention is not limited to flyback power converters or converters with only one stage. Embodiments of the invention might be boosters or converters with stages.

An embodiment of the invention provides an isolated AC-to-DC power supply with a flyback topology. The isolated AC-to-DC power supply converts an input power source on a primary side into an output power source on a secondary side galvanically isolated from the primary side. A transformer has primary and secondary windings on primary and secondary sides respectively, inductively coupled to each other. The AC-to-DC isolated power supply also has a power controller coupled to control a main switch connected in series with the primary winding between two input power lines coupled to the input power source. The main switch and a backup circuit with a backup power are controlled by the power controller, to increase or decrease the electromagnetic energy of the transformer, therefore generating power transfer cycles, each having a magnetization time and a demagnetization time. One magnetization time refers to a time period when the electromagnetic energy increases over time, possibly because the input power source or the backup power supplies electricity to the transformer. On the opposite one demagnetization time is a time period when the electromagnetic energy decreases over time, possibly because the electromagnetic energy is released to supply electricity to the output power source or the backup power. A power transfer cycle may further include a break time, referring to a time period when the transformer is not energized by any power source, nor releasing its electromagnetic energy to supply a power source with electricity. During a break time, LC resonance might happen due to a resonant circuit consisting of the transformer and peripheral or parasitic capacitors. During a first power transfer cycle when the input power source is relatively low in voltage, the magnetization time of the first power transfer cycle has an internal-burst slot and an input slot, during which the backup power and the input power source are used respectively to supply electricity to the transformer. The employment of the internal-burst slot is to compensate for the shortage of input power limitedly provided by the input power source when the input power source is relatively-low in voltage. During a second power transfer cycle when the input power source is relatively high in voltage, the demagnetization time of the second power transfer cycle has an internal-storage slot and an output slot, during which the electromagnetic energy of the transformer is released to supply electricity to the backup power and the output power source respectively. When the input power source is high in voltage, the excessive input power abundantly drained from the input power source is adaptively distributed to the backup power and the output power source, so the output power source can be well regulated, and the backup power is accordingly built up. Therefore, only one stage with a single transformer is needed to achieve both PFC and output regulation.

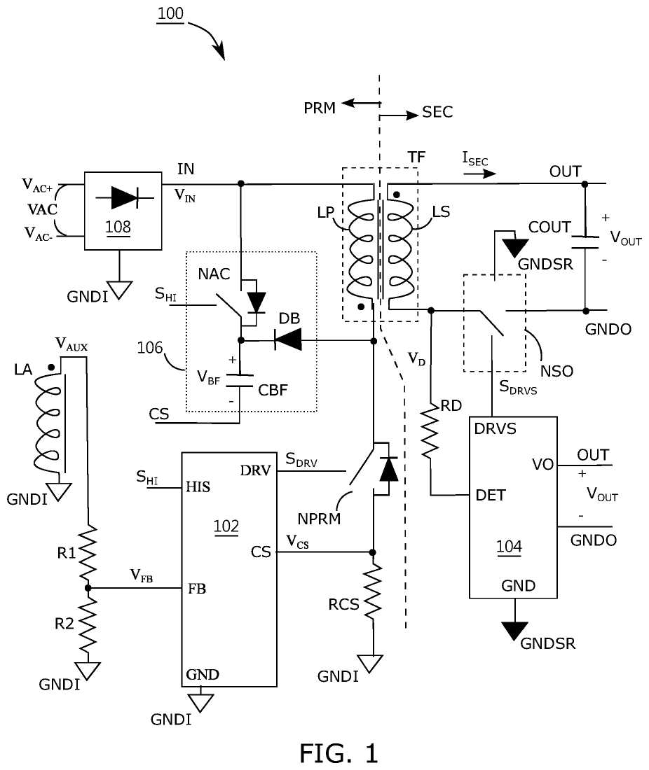

FIG. 1 demonstrates AC-to-DC (alternating-current-to-direct-current) power supply 100 with galvanic isolation between primary side PRM and secondary side SEC. Bridge rectifier 108 provides full wave rectification, supplying input power source V_{IN} at input power line IN and an input ground at input ground line GNDI, where the voltage of the input ground is deemed as 0V for signals or voltages in primary side PRM. AC-to-DC power supply 100 is capable of converting input power source V_{IN} on primary side PRM into output power source V_{OUT} across output capacitor COUT on secondary side SEC.

On primary side PRM, AC-to-DC power supply 100 has bridge rectifier 108, primary winding LP and auxiliary winding LA of transform TF, primary-side controller 102, backup circuit 106, main switch NPRM, current-sense resistor RCS, voltage-dividing resistors R1 and R2, the connection of which is shown in FIG. 1. Backup circuit 106 has discharge switch NAC, diode DB, and capacitor CBF. Capacitor CBF provides backup power V_{BF}, having one end connects to the joint between discharge switch NAC and diode DB, and the other to current-sense node CS, the joint between primary winding LP and current-sense resistor RCS. In FIG. 1, each of main switch NPRM and discharge switch NAC is drawn with a body diode therein, and could be any kind of power switch, which could be and is not limited to be a NMOS transistor, a PMOS transistor, a GaN (Gallium Nitride) transistor, a bipolar junction transistor, or the combination of a NMOS transistor and a GaN transistor. In one embodiment, a synchronous rectifier replaces diode DB to reduce the conduction loss caused by the forward voltage of diode DB.

On secondary side SEC, AC-to-DC power supply 100 has secondary-side controller 104, secondary-side switch NSO, secondary winding LS of transformer TF, and detection resistor RD, the connection of which is shown in FIG. 1. In one embodiment, secondary-side switch NSO is a bidirectional switch, which, when turned ON, provides a short circuit between secondary winding LS and output ground line GNDO, and, when turned OFF, converts the short circuit into an open circuit isolating secondary winding LS from output ground line GNDO. In one embodiment of the invention, secondary-side switch NSO has two NMOS transistors back-to-back connected, and in another embodiment, it has two GaN transistor back-to-back connected. If secondary-side switch NSO is composed of two transistors, these transistors need not be controlled by the same signal, and one of them might be turned ON while the other is turned OFF to turn OFF the secondary-side switch NSO. Furthermore, according to embodiments of the invention, secondary-side switch NSO might have two transistors, one connected between output ground line GNDO and an end of secondary winding LS, and the other connected between the other end of secondary winding LS and output power line OUT providing output power source V_{OUT}. In FIG. 1, secondary-side switch NSO has four nodes, connected to output ground line GNDO, secondary winding LS, drive pin DRVS of secondary-side controller 104, and reference power line GNDSR (ground pin GND of secondary-side controller 104), respectively.

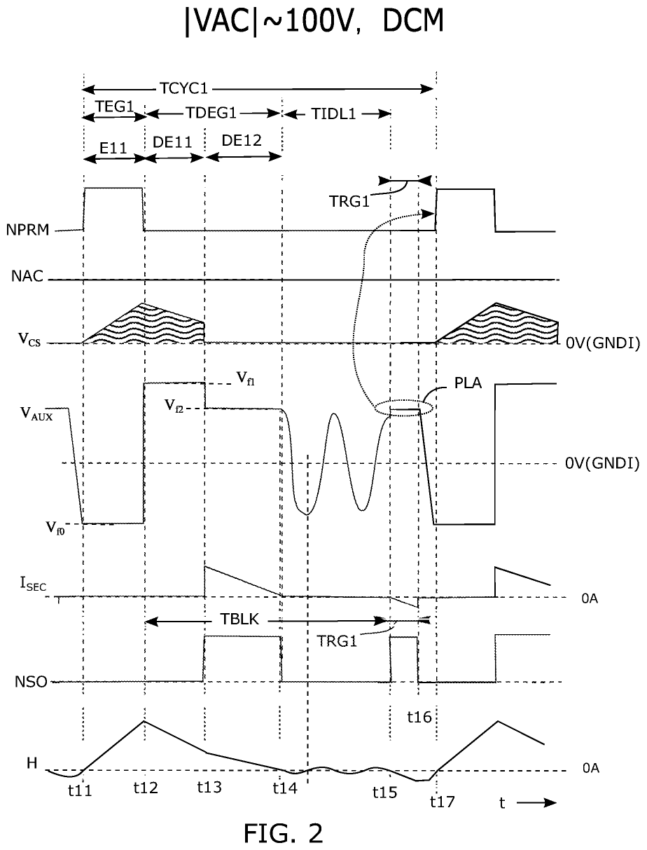

FIG. 2 demonstrates how AC-to-DC power supply 100 achieves both PFC and output regulation at the same time when the absolute voltage value of AC mains power VAC supplied from a wall socket is relatively high, or about 100V for example. AC-to-DC power supply 100 may operate under secondary-side domination, hereinafter meaning that the beginning of a power transfer cycle is triggered by secondary-side controller 104, which signals primary-side controller 102 by turning ON or OFF secondary-side switch NSO. U.S. patent application Ser. No. 17/844,318, filed on Jun. 20th, 2022, and commonly owned by the Applicant of this patent application, teaches secondary-side domination and is incorporated by reference in its entirety.

FIG. 2 demonstrates that AC-to-DC power supply 100 is operating in DCM (discontinuous conduction mode), which means the electromagnetic energy H of transform TF drops to zero within a power transfer cycle. From top to bottom, FIG. 2 has the waveforms representing the logic status of main switch NPRM, the logic status of discharge switch NAC, current-sense signal V_{CS} at current-sense node CS, winding voltage V_{AUX} at one end of auxiliary winding LA, winding current I_{SEC} through secondary winding LS, the logic status of secondary-side switch NSO, and electromagnetic energy H stored by transform TF.

Secondary-side domination shown in FIG. 2 is achieved by turning ON secondary-side switch NSO, to generate plateau PLA during trigger time TRG1, so as to signal primary-side controller 102, which accordingly ends the present power transfer cycle and starts the next power transfer cycle. Secondary-side domination in FIG. 2 uses transformer TF as a media to send signals from secondary side SEC to primary side PRM, and needs no additional photo-couplers, capacitors, or inductive devices for signal transmission across secondary side SEC and primary side PRM. Nevertheless, embodiments of the invention are not limited to those using secondary-side domination and might use a photo-coupler for example for signal transmission.

Transformer TF is controlled to generate power transfer cycles, each including at least a magnetization time and a demagnetization time. Embodiments of the invention teach that during each power transfer cycle main switch NPRM is only switched ON and OFF once. FIG. 2 demonstrates power transfer cycle TCYC1, including, from left to right, magnetization time TEG1, demagnetization time TDEG1, break time TIDL1, and trigger time TRG1. At moment t17 after trigger time TRG1, power transfer cycle TCYC1 ends and the next power transfer cycle starts. Magnetization time TEG1 only has input slot E11, while demagnetization time TDEG1 has internal-storage slot DE11 and output slot DE12. According to other embodiments, magnetization time TEG1 might have an internal-burst slot, which will be detailed later.

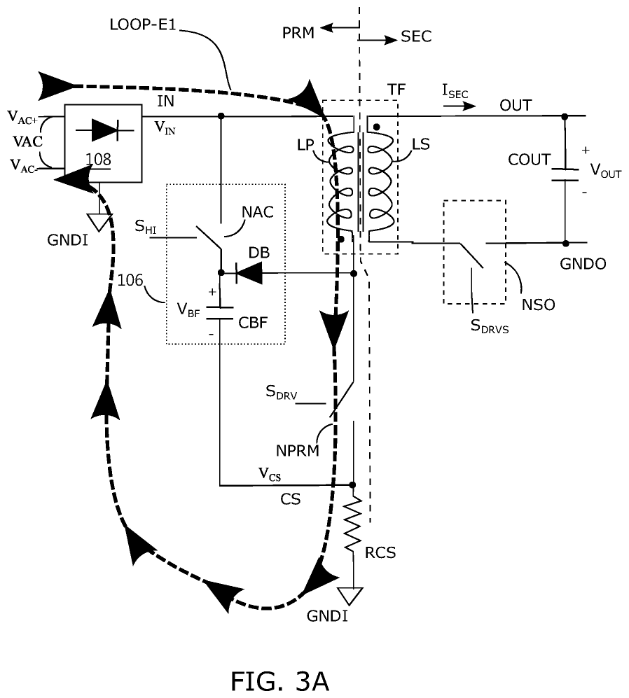

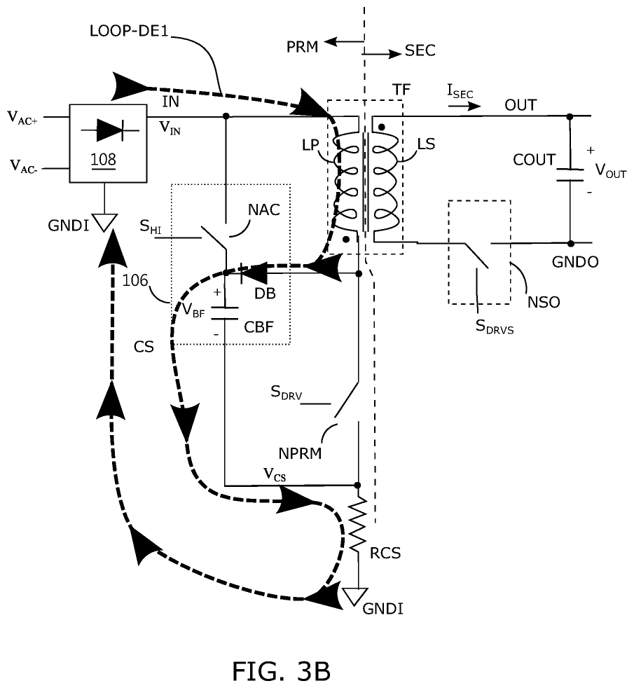

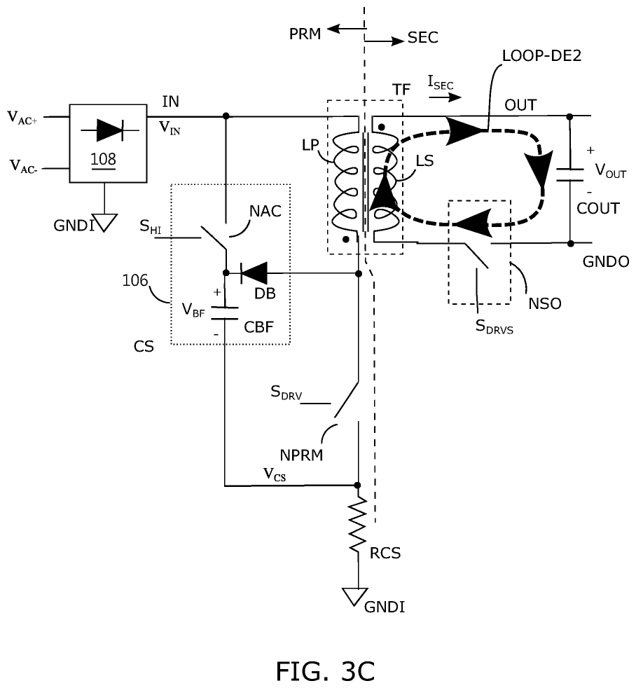

FIG. 3A demonstrates current loop LOOP-E1 that increases electromagnetic energy H of transformer TF during input slot E11 of FIG. 2. Shown in FIG. 2, main switch NPRM is ON, and both discharge switch NAC and secondary-side switch NSO are OFF during input slot E11 from moment t11 to moment t12. As shown in FIG. 3A, current loop LOOP-E1 drains current from AC mains power VAC to increase electromagnetic energy H that transformer TF stores. During input slot E11, current-sense signal V_{CS} increases linearly over time, and winding voltage V_{AUX} has voltage value V_{f0} reflecting input power source V_{IN}, which in the meantime is about 100V, the absolute voltage value of AC mains power VAC.

FIG. 3B demonstrates current loop LOOP-DE1 that decreases electromagnetic energy H of transformer TF during internal-storage slot DE11 (from moment t12 to moment t13) in FIG. 2. During internal-storage slot DE11, main switch NPRM, discharge switch NAC and secondary-side switch NSO, all are turned OFF, as shown in FIG. 2. Releasing electromagnetic energy H, current loop LOOP-DE1 in FIG. 3B conducts current from AC mains power VAC to charge capacitor CBF via primary winding LP and diode DB. Part of electromagnetic energy H currently stored by transformer TF is released to build up or supply electricity to backup power V_{BF}. As electromagnetic energy H decreases, current-sense signal V_{CS} decreases over time. In the meantime, winding voltage V_{AUX} in FIG. 2 has voltage value V_{f1} substantially reflecting the difference between backup power V_{BF} and input power source V_{IN}. FIG. 3B also demonstrates that electromagnetic energy H does not release to output power source V_{OUT} during internal-storage slot DE11.

FIG. 3C demonstrates current loop LOOP-DE2 that decreases electromagnetic energy H of transformer TF during output slot DE12 (from moment t13 to moment t14) in FIG. 2. During output slot DE12, secondary-side switch NSO is turned ON, but main switch NPRM and discharge switch NAC are turned OFF. Releasing electromagnetic energy H, current loop LOOP-DE2 in FIG. 3C conducts winding current I_{SEC} through secondary winding LS and secondary-side switch NSO to charge output capacitor COUT and supply power to output power source V_{OUT}. Electromagnetic energy H stored by transformer TF is transformed to the electricity supplied to output power source V_{OUT}. FIG. 3C also demonstrates that electromagnetic energy H does not release to backup power V_{BF} during output slot DE12. Meanwhile, no current is drained from AC mains power VAC, so current-sense signal V_{CS} is about 0V. As shown in FIG. 2, during output slot DE12, winding current I_{SEC} decreases over time, and winding voltage V_{AUX} has voltage value V_{f2} reflecting output power source V_{OUT}. For example, secondary-side switch NSO is turned ON at the beginning of output slot DE12, and turned OFF to end output slot DE12 at moment t14 when secondary-side controller 104 found winding current I_{SEC} is about 0 A. It can be understood from FIG. 2 that the voltage drop across secondary winding LS during internal-storage slot DE11 is higher than that during output slot DE12 because voltage value V_{f1} exceeds voltage value V_{f2}.

During demagnetization time TDEG1, electromagnetic energy H stored by transformer TF is released to supply electricity to either output power source V_{OUT} or backup power V_{BF}. Since no current flows through transformer TF at moment t14, electromagnetic energy H is depleted at moment t14, so AC-to-DC power supply 100 in FIG. 2 is operating in DCM.

In FIG. 2, during break time TIDL1, from moment t14 to moment t15, main switch NPRM, discharge switch NAC, and secondary-side switch NSO all are turned OFF. Meanwhile, an LC resonance circuit composed of transistor TF and some parasitic capacitors starts resonating in response to some initial power stored in the parasitic capacitors. Accordingly, during break time TIDL1, winding voltage V_{AUX} vibrates as shown in FIG. 2.

Secondary-side controller 104 in FIG. 1 turns ON secondary-side switch NSO during trigger time TRG1 (from moment t15 to moment t16) in FIG. 2, while main switch NPRM and discharge switch NAC are turned OFF. During trigger time TRG1, winding voltage V_{AUX} as shown in FIG. 2 has plateau PLA with a height of voltage value V_{f2} and a width of the duration of trigger time TRG1. Finding the occurrence of plateau PLA via resistors R1 and R2, primary-side controller 102 accordingly turns ON main switch NPRM at moment t17 to end power transfer cycle TCYC1 and to start a new power transfer cycle. During trigger time TRG1, output power source V_{OUT} energizes transformer TF, whose electromagnetic energy H increases with a polarity opposite to the polarity when electromagnetic energy H has during magnetization time TEG1 and demagnetization time TDEG1, as shown in FIG. 2.

The duration of input slot E11 in FIG. 2 is determined in response to input power source V_{IN} and current-sense signal V_{CS}, to achieve PFC and to regulate backup power V_{BF}. For example, primary-side controller 102 determines the duration of input slot E11 based on input power source V_{IN} and the shaded area under the waveform of current-sense signal V_{CS} shown in FIG. 2, making the average of current-sense signal V_{CS} proportional to the voltage of input power source V_{IN} while regulating the voltage value of backup power V_{BF} roughly at a predetermined value, so as to control PF of AC-to-DC power supply 100 and to achieve PFC. Current-sense signal V_{CS} substantially reflects the current drained from AC mains power VAC, and input power source V_{IN} reflects the absolute voltage value of AC mains power VAC. If the average of current-sense signal V_{CS} is proportional to the voltage of input power source V_{IN}, PF is about 1, the ideal value, and PFC is achieved. Primary-side controller 102 may receive information of input power source V_{IN} by detecting voltage value V_{f0} during input slot E11. In one embodiment, primary-side controller 102 receives information of backup power V_{BF} from voltage value V_{f1} during internal-storage slot DE11. The ratio of the average of current-sense signal V_{CS} to the present voltage of input power source V_{IN} is determined by backup power V_{BF}, to regulate backup power V_{BF}. For example, the higher backup power V_{BF} the lower the ratio.

Blanking time TBLK refers to as the period from moment t12 to moment t15 in FIG. 2. In one embodiment, secondary-side controller 104 modulates blanking time TBLK to regulate output power source V_{OUT}. For example, if output power source V_{OUT} exceeds a predetermined target, implying output power source V_{OUT} is still abundant in power, blanking time TBLK lasts to delay the start of the next power transfer cycle. In case that output power source V_{OUT} is found to be below the predetermined target, secondary-side controller 104 ends blanking time TBLK to start trigger time TRG1, so as to signal primary-side controller 102, which accordingly starts a new power transfer cycle a delay after the end of trigger time TRG1. Accordingly, secondary-side controller 104 regulates output power source V_{OUT} at the predetermined target. Another embodiment might use an error amplified to compare output power source V_{OUT} with the predetermined target, so as to generate a compensation voltage, which determines the length of blanking time TBLK. The higher output power source V_{OUT} than the predetermined target, the higher the compensation voltage, the longer blanking time TBLK.

The duration of trigger time TRG1 should be at least long enough for primary-side controller 102 to detect its existence and could be further adjusted to help ZVS (zero-voltage-switching) on main switch NPRM according to some embodiments of the invention.

The duration of internal-storage slot DE11 is controlled by secondary-side controller 104 in response to for example a previous power transfer cycle or another blanking time TBLK before power transfer cycle TCYC1. From another point of view, secondary-side controller 104 modulates the duration of internal-storage slot DE11 to regulate the length of power transfer cycle TCYC1 or blanking time TBLK. In an embodiment of the invention, if power transfer cycle TCYC1 or blanking time TBLK is longer/shorter than a target length, implying that the power transferring to output power source V_{OUT} in power transfer cycle TCYC1 might be too much/little, then, in a next power transfer cycle, secondary-side controller 104 lengthens/shortens internal-storage slot DE11, so as to increase/decrease the portion of electromagnetic energy H releasing to backup power V_{BF}, to decrease/increase the portion releasing to output power source V_{OUT}, so as to expectedly shorten/lengthen the next power transfer cycle or the next blanking time. For example, the target length that power transfer cycle TCYC1 approaches can be determined based on the load which output power source V_{OUT} supplies power to. The lighter load the longer target length. The load could be determined by the average current flowing through secondary-side switch NSO. The existence of internal-storage slot DE11 is also an indication showing that electromagnetic energy H is enough for regulating output power source V_{OUT}.

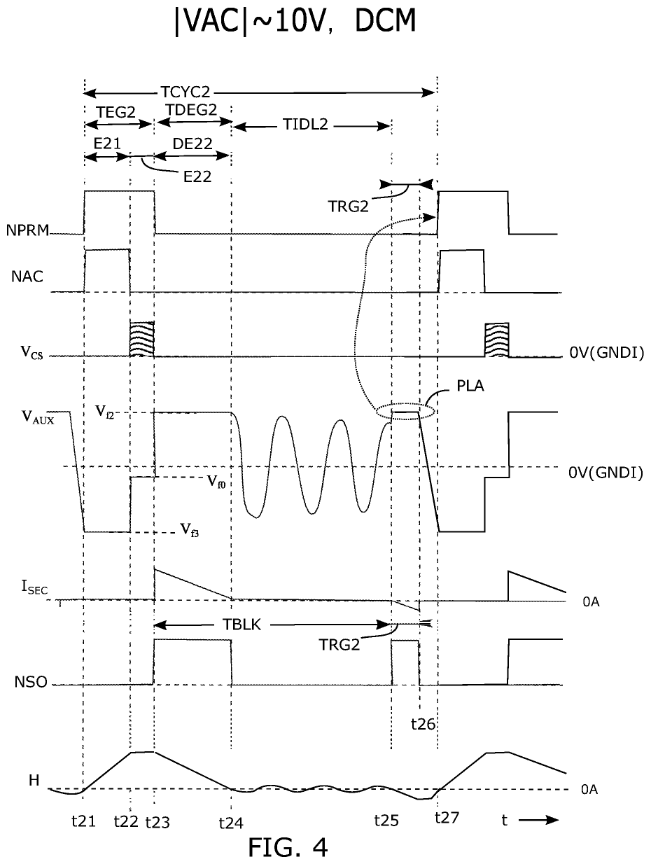

FIG. 4 demonstrates how AC-to-DC power supply 100 achieves PFC and output regulation at the same time when the absolute voltage value of AC mains power is relatively low or about 10V for example. FIG. 4 is similar to FIG. 2, and the same or similar aspects therebetween are comprehensible in view of the teaching regarding to FIG. 2. FIG. 4 demonstrates power transfer cycle TCYC2, including, from left to right, magnetization time TEG2, demagnetization time TDEG2, break time TIDL2, and trigger time TRG2. At moment t27 after trigger time TRG2, power transfer cycle TCYC2 ends and the next power transfer cycle starts. Magnetization time TEG2 has internal-burst slot E21 and input slot E22, while demagnetization time TDEG1 has output slot DE22. Demagnetization time TDEG2 might additionally have an internal-storage slot in another embodiment.

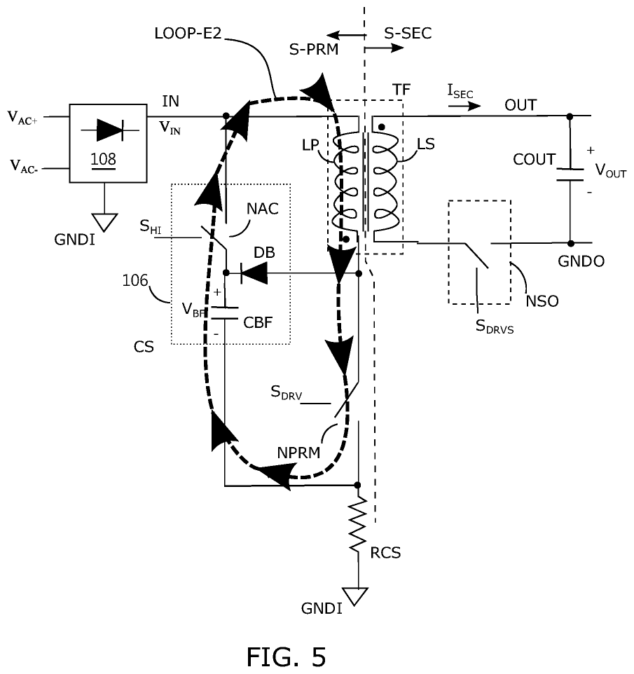

FIG. 5 demonstrates current loop LOOP-E2 that increases electromagnetic energy H of transformer TF during internal-burst slot E21 of FIG. 4. During internal-burst slot E21, from moment t21 to moment t22 in FIG. 4, both main switch NPRM and discharge switch NAC are ON, and secondary-side switch NSO is OFF. As shown in FIGS. 4 and 5, current loop LOOP-E2 releases backup power V_{BF} to increase electromagnetic energy H over time. Current-sense signal V_{CS} is 0V during internal-burst slot E21 in FIG. 4 because bridge rectifier 108 blocks reverse current flowing toward to AC mains power VAC. During internal-burst slot E21, winding voltage V_{AUX} has voltage value V_{f3} reflecting input power source V_{IN}, which in the meantime is substantially equal to backup power V_{BF}. In other words, voltage value V_{f3} reflects backup power V_{BF}, and can be used to determine the ratio of the average of current-sense signal V_{CS} to input power source V_{IN} to achieve PFC according to some embodiments of the invention. As PFC requires, the power supplied from AC mains power VAC when the absolute value of AC mains power VAC is low must be limited, and very likely is not enough to support output power source V_{OUT}. Therefore, in order to fill up the power shortage from AC mains power VAC, discharge switch NAC is turned ON, and backup power V_{BF} jointly supplies power to increase electromagnetic energy H of transformer TF during internal-burst slot E21, so output power source V_{OUT} could be well regulated.

Input slot E22, output slot DE22, break time TIDL2, and trigger time TRG2 in FIG. 4 are similar to input slot E11, output slot DE12, break time TIDL1, and trigger time TRG1 in FIG. 2 respectively, and are comprehensible in view of the previous teaching regarding FIG. 2. Simply speaking, during input slot E22, main switch NPRM is turned ON and discharge switch NAC is OFF, to let input power source V_{IN}, which is currently supplied by AC mains power VAC, increase electromagnetic energy H of transformer TF. The duration of input slot E22 is controlled to regulate both power factor (PF) and backup power V_{BF}. During output slot DE22, secondary-side switch NSO acts as a synchronous rectifier, and electromagnetic energy H is released to build up output power source V_{OUT}. During break time TIDL2, the resonant circuit consisting of transformer TF and parasitic capacitors starts resonating because of the residue energy left on the parasitic capacitors. During trigger time TRG2, secondary-side controller turns ON secondary-side switch NSO to signal the request of a new power transfer cycle to primary-side controller 102, which in response starts the next power transfer cycle.

Another embodiment of the invention has internal-burst time E21 after input slot E22. Nevertheless, internal-burst time E21 preferably precedes input slot E22, as shown in FIG. 4, to shorten both input slot E22 and magnetization time TEG2. In the embodiment of FIG. 4 showing that internal-burst time E21 precedes input slot E22, backup power V_{BF}, whose voltage is much higher than the present absolute voltage value of AC mains power V_{AC}, causes to increase current-sense signal V_{CS} significantly during internal-burst time E21, so input slot E22 could be very brief to achieve expected PF. In some embodiments where input slot E22 precedes internal-burst time E21, current-sense signal V_{CS} during input slot E22 may increase slower, and input slot E22 possibly becomes much longer to achieve expected PF.

The duration of internal-burst time E21 can be determined by primary-side controller 102, in response to the internal-storage slot, demonstrated by internal-storage slot DE11 in FIG. 2, in a previous power transfer cycle. As mentioned before, the existence of internal-storage slot DE11 in FIG. 2 for example is an indication showing that electromagnetic energy H is enough for regulating output power source V_{OUT}. The disappearance of internal-storage slot DE11 indicates that electromagnetic energy H may not be enough and backup power V_{BF} need join to transfer more energy by way of internal-burst time E21, to support output power source V_{OUT}. For example, if the internal-storage slot within the previous power transfer cycle that just ended is longer than a predetermined length, primary-side controller 102 shortens or eliminates internal-burst time E21. In the opposite, if the internal-storage slot within the previous power transfer cycle disappears or is shorter than the predetermined length, primary-side controller 102 inserts or lengthens internal-burst time E21. Accordingly, even though there is no internal-storage slot in FIG. 4, a power transfer cycle according to embodiments of the invention might has an internal-storage slot inserted at any moment within demagnetization time TDEG2.

Even though each of magnetization times TEG1 and TEG2 of FIGS. 2 and 4 has an input slot, during which AC mains power VAC supplies power to increase electromagnetic energy H of transformer TF, the invention is not limited to however. A magnetization time according to embodiments of the invention might have no input slot but an internal-burst slot, during which backup power V_{BF} supplies power to increase electromagnetic energy H of transformer TF. For example, for a power transfer cycle when AC mains power VAC is currently about 0V, the current supplied from AC mains power VAC, which PFC requires to be proportional to 0V (the present voltage of AC mains power VAC), should be 0 A, so the power transfer cycle has no input slot, but an internal-burst slot during which backup power V_{BF} supplies power to regulate output power source V_{OUT}.

Secondary-side controller 102 produces trigger times TRG1 and TRG2 not only to signal primary-side controller 102 via transformer TF, but also to make soft switching or ZVS possible for both main switch NPRM and discharge switch NAC. Soft switching refers to that a switch is turned ON to conduct current when the voltage drop across two ends of the conductive tunnel of the switch is about zero, and is well known to reduce switching loss.

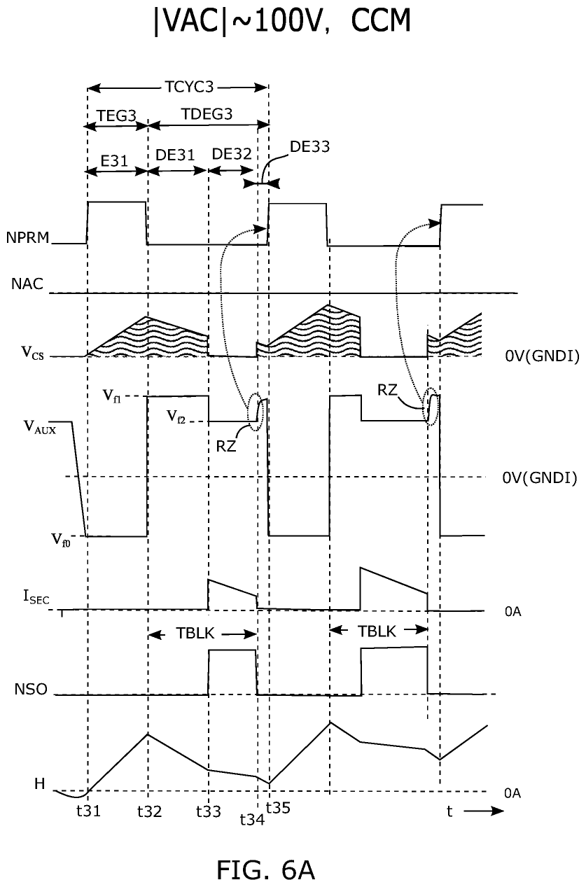

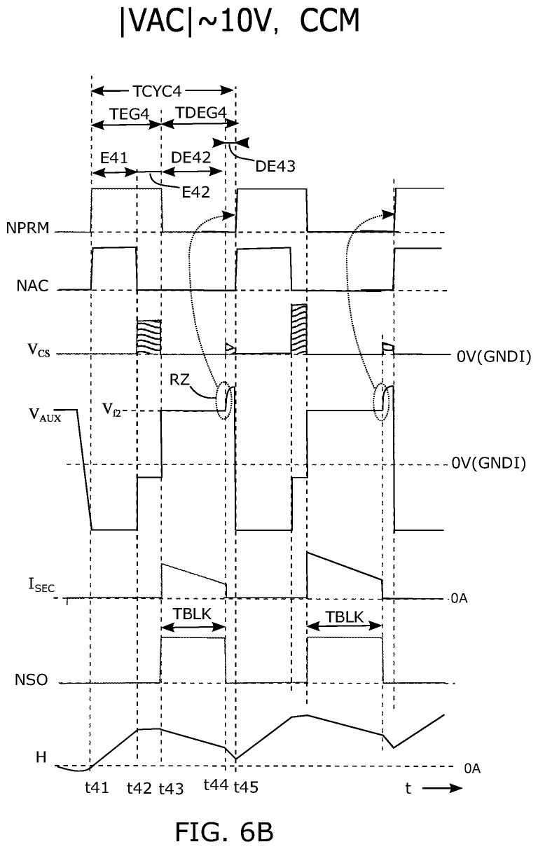

Both FIGS. 2 and 4 demonstrate that AC-to-DC power supply 100 operates in DCM, but this invention is not limited to however. It is possible that AC-to-DC power supply 100 according to embodiments of the invention operates in CCM (continuous conduction mode) or BM (boundary mode). Each of FIGS. 6A and 6B has switch statuses and waveforms showing that AC-to-DC power supply 100 operates in CCM, FIG. 6A corresponds to the condition when the absolute voltage value of AC mains power is relatively high, or about 100V for example, and FIG. 6B corresponds to the condition when the absolute voltage value of AC mains power is relatively low, or about 10V for example.

Some aspects in FIG. 6A are similar or the same with corresponding aspects in FIG. 2, and comprehensible in view of the teaching regarding FIG. 2. From left to right, power transfer cycle TCYC3 in FIG. 6A has magnetization time TEG3 and demagnetization time TDEG3. As shown in FIG. 6A, magnetization time TEG3 has only input slot E31, while demagnetization time TDEG3 has internal-storage slot DE31, output slot DE32 and internal-storage slot DE33. Power transfer cycle TCYC3 ends at moment t35 when another power transfer cycle starts. Input slot E31 and internal-storage slot DE31 in FIG. 6A are self-explanatory, corresponding to input slot E11 and internal-storage slot DE11 in FIG. 2.

Output slot DE32 in FIG. 6A is similar to output slot DE12 in FIG. 2, releasing electromagnetic energy H to supply power to output power source V_{OUT}. Nevertheless, blanking time TBLK in FIG. 6A that secondary-side controller 104 determines ends earlier at moment t34, probably because of a heavier load that causes output power source V_{OUT} to be lower. As blanking time TBLK ends at moment t34 to conclude output slot DE32, secondary-side controller 104 turns OFF secondary-side switch NSO to stop transformer TF supplying current to output power source V_{OUT}. Nevertheless, at moment t34, electromagnetic energy H of transformer TF is not completely depleted as it is shown in FIG. 6A that winding current I_{SEC} is still positive right before moment t34.

Internal-storage slot DE33 follows output slot DE32. During internal-storage slot DE33, electromagnetic energy H is released to supply power to backup power V_{BF}. Accordingly, winding voltage V_{AUX} rises sharply at moment t34, the beginning of internal-storage slot DE33, to generate rising edge RZ as shown in FIG. 6A. Primary-side controller 102 detects the appearance of rising edge RZ (the beginning of internal-storage slot DE33) via voltage-dividing resistors R1 and R2, to acknowledge the end of blanking time TBLK, so as to start a new power transfer cycle soon after and to end internal-storage slot DE33. As shown in FIG. 6A, electromagnetic energy H in FIG. 6A never returns to 0 A during power transfer cycle TCYC3, so AC-to-DC power supply 100 currently operates in CCM.

Duration of internal-storage slot DE33 is determined by primary-side controller 102. Internal-storage slot DE33 certainly ends when winding current I_{SEC} is about 0 A. In one example, internal-storage slot DE33 is not more than a maximum length so AC-to-DC power supply 100 could operate in CCM. In another example, internal-storage slot DE33 lasts until winding current I_{SEC} is about 0 A, and primary-side controller 102 starts a new power transfer cycle soon after winding voltage V_{AUX} drops below 0V, the indication of a voltage valley, so AC-to-DC power supply 100 operates in BM.

Shown in FIG. 2, secondary-side controller 104 signals primary-side controller 102 the end of blanking time TBLK by turning ON secondary-side switch NSO after electromagnetic energy H is depleted, so AC-to-DC power supply 100 operates in DCM. Shown in FIG. 6A, nevertheless, before electromagnetic energy H is depleted, secondary-side controller 104 signals primary-side controller 102 the end of blanking time TBLK by turning OFF secondary-side switch NSO, so AC-to-DC power supply 100 operates in CCM or BM.

FIG. 6B is similar to FIG. 4, and the similar or the same aspects therebetween are comprehensible given the teaching regarding FIG. 4. From left to right, power transfer cycle TCYC4 in FIG. 6B has magnetization time TEG4 and demagnetization time TDEG4. Magnetization time TEG4 has internal-burst slot E41 and input slot E42, and demagnetization time TDEG4 has output slot DE42 and internal-storage slot DE43. Power transfer cycle TCYC4 ends at moment t45 when another power transfer cycle starts. Internal-burst slot E41, input slot E42 and output slot DE42 in FIG. 6B are self-explanatory, corresponding to internal-burst slot E21, input slot E22 and output slot DE22 in FIG. 4. Internal-storage slot DE43 in FIG. 6B is comprehensible given the previous teaching regarding internal-storage slot DE33 in FIG. 6A.

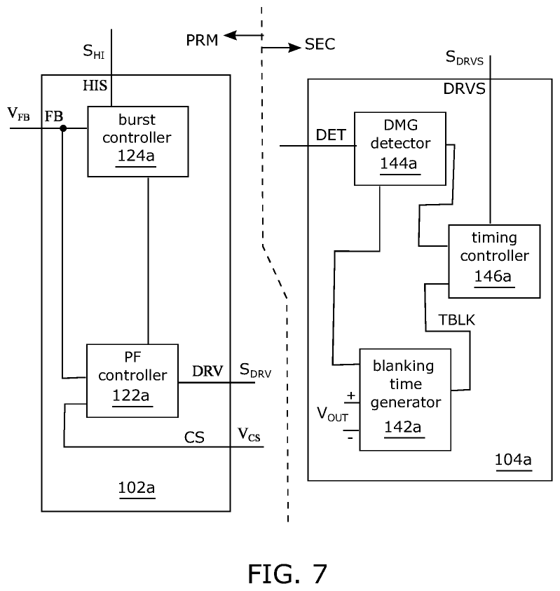

FIGS. 2, 4, 6A and 6B teach how AC-to-DC power supply 100 uses secondary-side domination to regulate output power source V_{OUT} and achieve PFC at the same time. FIG. 7 demonstrates primary-side controller 102a and secondary-side controller 104a, both suitable to be used in AC-to-DC power supply 100.

Primary-side controller 102a has PF controller 122a and burst controller 124a, controlling main switch NPRM and discharge switch NAC via driving nodes DRV and HIS respectively. PF controller 122a receives current-sense signal V_{CS} from current-sense node CS and detects winding voltage V_{AUX} via feedback signal V_{FB} at feedback node FB. In response to current-sense signal V_{CS} (reflecting the current flowing to bridge rectifier 108) and voltage value V_{f0} (the value of winding voltage V_{AUX} during an input slot, reflecting input power source V_{IN}), PF controller 122a controls power factor of AC-to-DC power supply 100. The ratio of input power source V_{IN} to the average of current-sense signal V_{CS} is controlled by PF controller 122a to substantially regulate backup power V_{BF}, represented by voltage value V_{f3}, the value of winding voltage V_{AUX} during internal-burst slot E21 for example. For example, PF controller 122a controls to make PF about 1 and to regulate backup power V_{BF} at about 440V. From feedback node FB, burst controller 124a in FIG. 7 can detect an internal-storage slot after main switch NPRM is turned OFF, to control discharge switch NAC. For example, if the internal-storage time in a previous power transfer cycle is shorter than expected, or even disappears, burst controller 124a lengthens an internal-burst slot, so backup power V_{BF} supplies more power to transformer TF or output power source V_{OUT}. If the internal-storage time in a previous power transfer cycle is longer than expected, the next internal-burst slot is shortened or removed. Burst controller 124a modulates an internal-burst slot in response to a previous internal-storage time. Burst controller 124a equally helps to regulate output power source V_{OUT}, because output power regulation is very likely to fail if an internal-storage time does not appear.

Secondary-side controller 104a has DMG (demagnetization) detector 144a, blanking time generator 142a, and timing controller 146a. Via detection node DET, DMG detector 144a senses the beginning and the end of a demagnetization time, for example, moments t12 and t14 in FIG. 2. Blanking time generator 142a determines blanking time TBLK in response to output power source V_{OUT}. Timing controller 146a controls secondary-side switch NSO in response to blanking time TBLK and the demagnetization time that DMG detector 144a determines. For example, if blanking time TBLK ends after a demagnetization time ends, timing controller 146a turns ON secondary-side switch NSO to have winding voltage V_{AUX} generate plateau PLA as shown in FIG. 2 or 4, to signal primary-side controller 102a the end of blanking time TBLK. If blanking time TBLK ends before the end of the demagnetization time, timing controller 146a turns OFF secondary-side switch NSO to have winding voltage V_{AUX} generate rising edge RZ as shown in FIG. 6A or 6B, to signal primary-side controller 102a the end of blanking time TBLK. Furthermore, timing controller 146a controls the duration of an internal-storage slot, to regulate blanking time TBLK at a preferable value corresponding to the load that output power source V_{OUT} supplies power to. For example, in response to the current that output power source V_{OUT} currently supplies to a load, timing controller 146a determines that blanking time TBLK is preferably to be 10 us, but blanking time TBLK in the present power transfer cycle is actually 11 us as determined by the voltage of output power source V_{OUT}. Accordingly, timing controller 146a lengthens the internal-storage slot in a next power transfer cycle, so blanking time TBLK in the next power transfer cycle is expected to become shorter, approaching to 10 us, the preferable value.

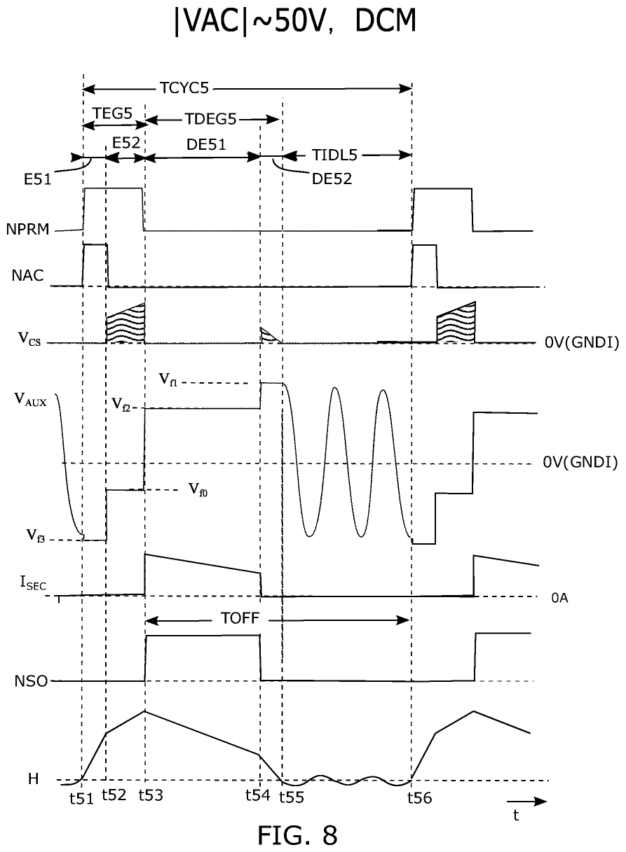

This invention is not limited to secondary-side domination, and is also applicable to a power supply using primary-side domination, meaning that the beginning of a power transfer cycle is determined and triggered by primary-side controller 102 which might take references provided from secondary-side controller 104. AC-to-DC power supply 100 could use primary-side domination to achieve both PFC and output regulation at the same time. FIG. 8 demonstrates power transfer cycle TCYC5 with magnetization time TEG5, demagnetization time TDEG5, and break time TIDL5. Some aspects in FIG. 8 are similar or the same with corresponding aspects in FIGS. 2, 4, 6A and 6B, and are comprehensible given the previous teaching regarding these drawings. At moment t56, the end of break time TIDL5, power transfer cycle TCYC5 ends and the next power transfer cycle starts. Magnetization time TEG5 includes internal-burst slot E51 and input slot E52. Demagnetization time TDEG5 has output slot DE51 and internal-storage slot DE52. Power transfer cycle TCYC5 lacks a trigger time that triggers the beginning of a new power transfer cycle.

In the embodiment of FIG. 8, the beginning and the end of power transfer cycle TCYC5 is determined by primary-side controller 102, while secondary-side controller 104 signals primary-side controller 102 via an isolation device, such as a photo-coupler, to lengthen or shorten a following power transfer cycle. In FIG. 8, secondary-side controller 104 does not trigger the beginning of a power transfer cycle. In response to the current that output power source V_{OUT} currently supplies to a load, secondary-side controller 104 determines that cycle time T=, the length of a power transfer cycle, is preferably to be a preferable value, and the difference between actual cycle time T_{CYC} and the preferable value can be sent as feedback via a photo coupler to primary-side controller 102 to adjust the next power transfer cycle, making cycle time T_{CYC} approach the preferable value cycle by cycle. Cycle time T_{CYC} may be limited by a maximum determined by voltage value V_{f3}, reflecting backup power V_{BF}. For example, secondary-side controller 104 may signal primary-side controller 102 to lengthen cycle time T_{CYC}, which however has reached the maximum, so primary-side controller 102 just keeps cycle time T_{CYC} the same in the next power transfer cycle.

Output slot DE51 in FIG. 8 is modulated by secondary-side controller 104 to regulate output power source V_{OUT}, and the higher voltage output power source V_{OUT} the shorter length output slot DE51. Input slot E52 is modulated by primary-side controller 102 to control PF, making the average of current-sense signal V_{CS} proportional to voltage value V_{f0}, which reflects the absolute value of AC mains power VAC during power transfer cycle TCYC5. The ratio of the average to voltage value V_{f0} is controlled to substantially regulate voltage value V_{f3}, or backup power V_{BF}. Internal-burst slot E51 is modulated to substantially keep the appearance of internal-storage slot DE52, and that appearance is an indication that energy currently transferred by transformer TF is enough for output power source V_{OUT} to be well regulated. For example, if internal-storage slot DE52 disappears, primary-side controller 102 increases stepwise the internal-burst slot in the next power transfer cycle. In the opposite, if the internal-storage slot has appeared for 5 consecutive power transfer cycles for example, primary-side controller 102 decreases stepwise the internal-burst slot in the next power transfer cycle. Accordingly, AC-to-DC power supply 100 with one single stage can achieve PFC and output regulation at the same time.

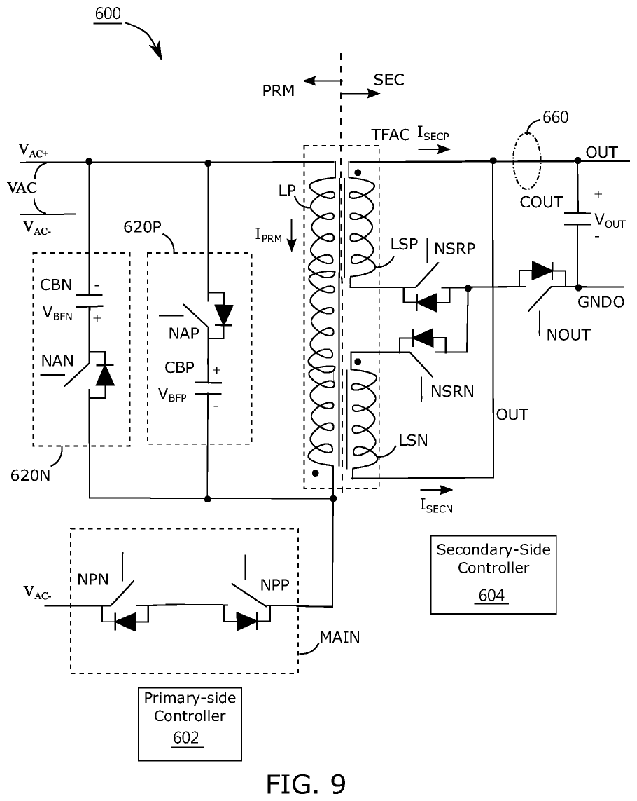

This invention is suitable not only for AC-to-DC power supplies with bridge rectifiers but also for AC-to-DC bridgeless power supplies. FIG. 9 demonstrates AC-to-DC bridgeless power supply 600 according to embodiments of the invention. FIGS. 9 and 1 have the same or similar aspects, which might not be detailed because they are comprehensible given the teaching regarding FIG. 1. AC-to-DC bridgeless power supply 600 might be controlled under primary-side domination or secondary-side domination, meaning the beginning of a power transfer cycle is triggered from primary side PRM or secondary side SEC.

A positive half period refers to the time period when node voltage V_{AC+} of AC mains power VAC is higher than node voltage V_{AC-} of AC mains power VAC. In the opposite, a negative half period refers to the time period when node voltage V_{AC+} of AC mains power VAC is lower than node voltage V_{AC-} of AC mains power VAC.

AC-to-DC bridgeless power supply 600 has, in primary side PRM, primary winding LP of transformer TFAC, active-clamping circuits 620P and 620N, main switch MAIN, and primary-side controller 602, the connection of which is shown in FIG. 9. Active-clamping circuits 620P and 620N, as two backup circuits, have discharge switches NAP and NAN respectively. Capacitor CBP in active-clamping circuit 620P provides backup power V_{BFP}, while capacitor CBN in active-clamping circuit 620N provides backup power V_{BFN}. Primary-side controller 602 controls main switch MAIN, and discharge switches NAP and NAN. AC-to-DC bridgeless power supply 600 has, in secondary side SEC, secondary windings LSP and LSN, secondary-side switches NSRP and NSRN, output switch NOUT, and output capacitor COUT, the connection of which is shown in FIG. 9. Secondary-side controller 604 controls secondary-side switches NSRP and NSRN, and output switch NOUT. AC-to-DC bridgeless power supply 600 in FIG. 9 is similar to the circuits shown FIGS. 3A, 7A-7D of U.S. patent Ser. No. 10/148,169, but AC-to-DC bridgeless power supply 600 operates in a different way.

Another embodiment of the invention relocates output switch NOUT to location 660 that separates output power line OUT from the joint node of secondary windings LSP and LSN, so output switch NOUT controls the current from secondary winding LSP or LSN to output capacitor COUT while output ground line GNDO electrically shorts to secondary-side switches NSRP and NSRN.

In FIG. 9, main switch MAIN is a bidirectional switch consisting of NMOS transistors NPP and NPN back-to-back connected. Main switch MAIN is only required to provide a short circuit connecting two ends when it is turned ON, and to turn the short circuit into an open circuit isolating the two ends from each other when it is turned OFF, so it may be composed of any kind of switches or transistors. Main switch MAIN acts to achieve two major functions: PFC and reverse-current-blocking. Main switch MAIN is controlled to block reverse current which flows from either node voltage V_{AC+} or node voltage V_{AC-}, whichever is lower, to either node voltage V_{AC+} or node voltage V_{AC-}, whichever is higher. Main switch MAIN is also controlled to make current drained from AC mains power VAC proportional to the present amplitude of AC mains power VAC.

In FIG. 9, backup powers V_{BFP} and V_{BFN} supply power to be transferred to output power source V_{OUT} when the power supplied from AC mains power VAC is insufficient during a positive half period and a negative half period respectively. Nevertheless, when the power supplied from AC mains power VAC is excessive, backup powers V_{BFP} and V_{BFN} store some power released from transformer TFAC during a negative half period and a positive half period respectively, so as to prevent output power source V_{OUT} from being overcharged.

In one embodiment, secondary-side switches NSRP and NSRN act as two synchronous rectifiers. Output switch NOUT, providing synchronous rectification at the same time, is controlled to regulate output power source V_{OUT}.

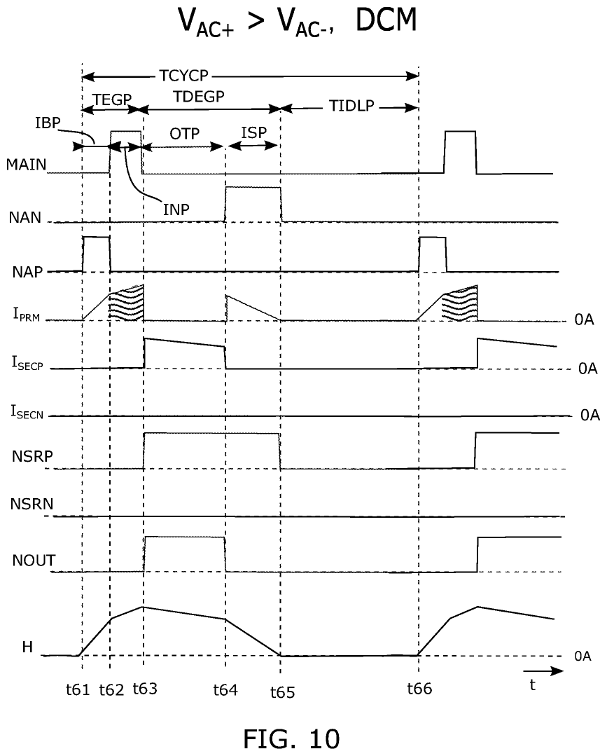

FIG. 10 demonstrates power transfer cycle TCYCP during a positive half period, and logic statuses and waveforms showing AC-to-DC bridgeless power supply 600 is operating in DCM. From top to bottom, FIG. 10 has waveforms representing the logic status of main switch MAIN, the logic statuses of discharge switches NAN and NAP, winding currents I_{PRM}, I_{SECP} and I_{SECN} through primary winding LP, secondary windings SECP and SECN respectively, the logic statuses of secondary-side switches NSRP and NSRN, the logic status of output switch NOUT, and electromagnetic energy H that transform TFAC stores. Sequentially, power transfer cycle TCYCP has magnetization time TEGP with internal-burst slot IBP and input slot INP, demagnetization time TDEGP with output slot OTP and internal-storage slot ISP, and break time TIDLP. AC-to-DC bridgeless power supply 600 operates in DCM because electromagnetic energy H drops to 0 A during power transfer cycle TCYCP. According to some embodiments of the invention, magnetization time TEGP may lack either internal-burst slot IBP or input slot INP, and/or demagnetization time TDEGP may lack either output slot OTP or internal-storage slot ISP.

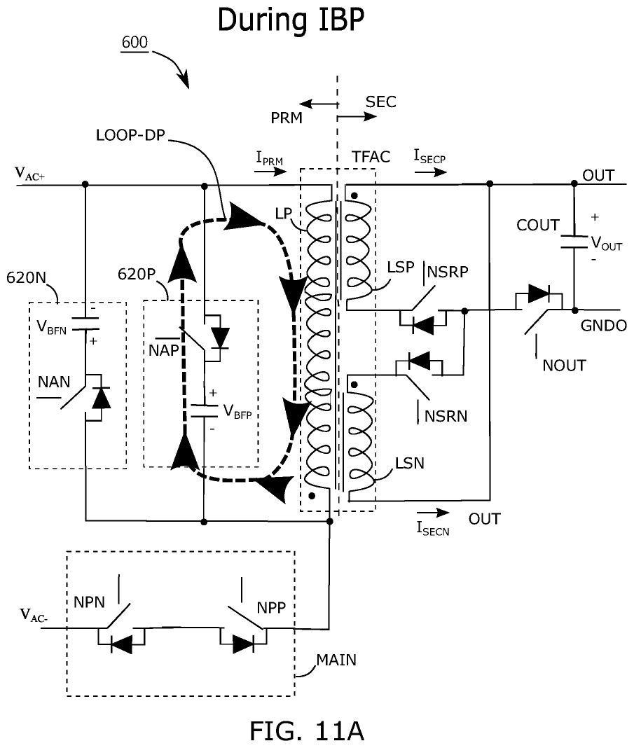

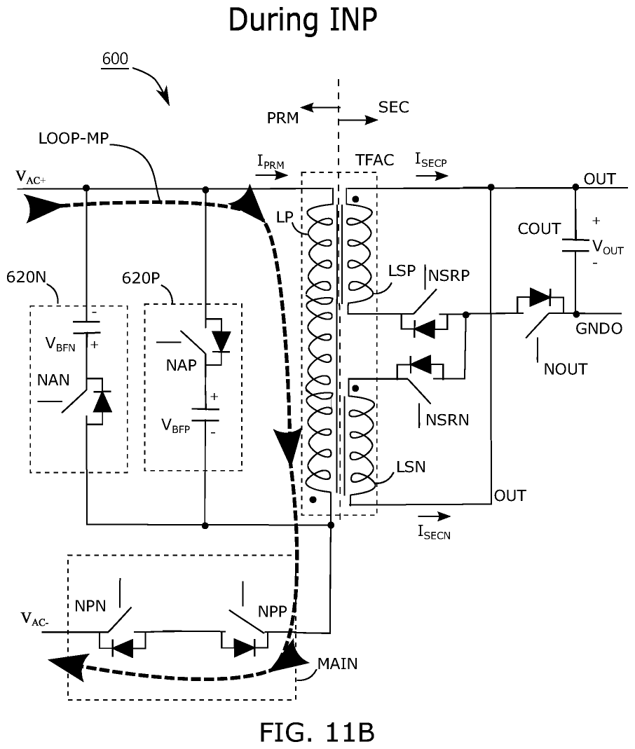

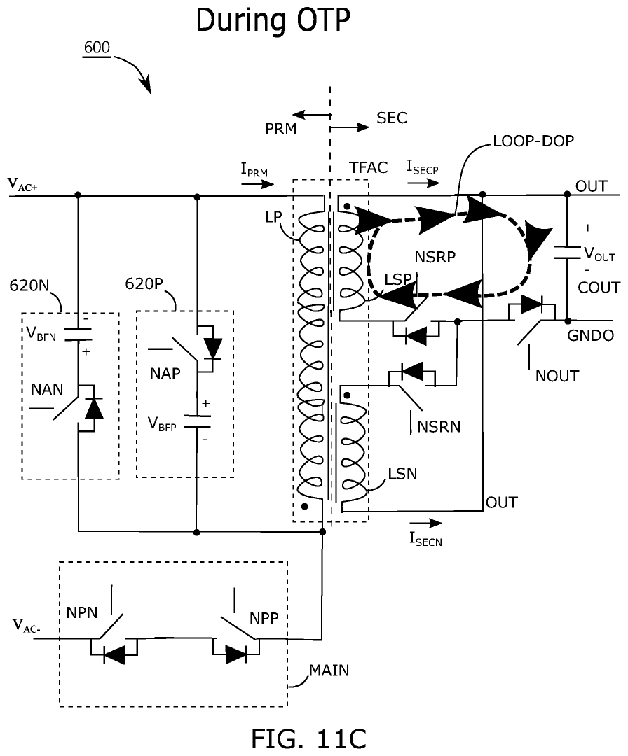

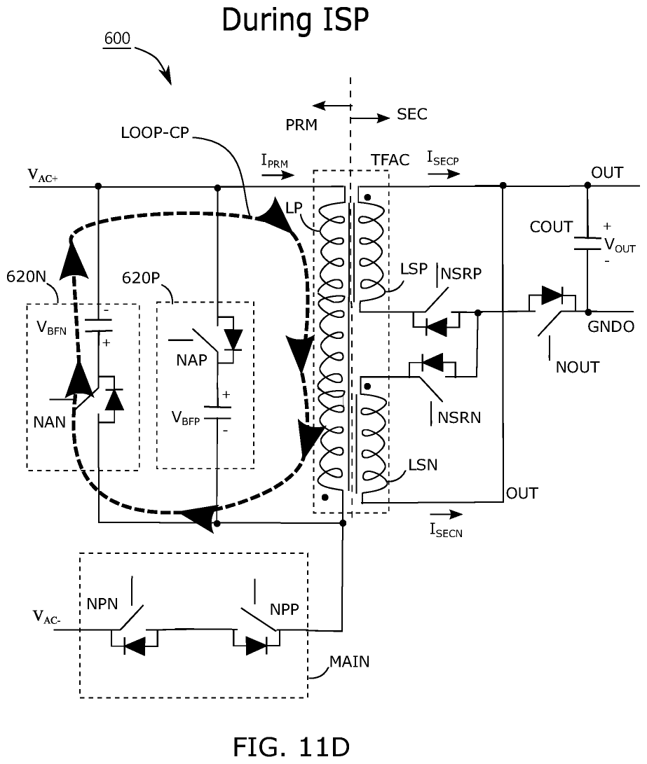

FIG. 11A demonstrates current loop LOOP-DP that increases electromagnetic energy H of transformer TFAC during internal-burst slot IBP of FIG. 10. Shown in FIG. 10, discharge switch NAP is ON, but main switch MAIN, discharge switch NAN, secondary-side switches NSRP and NSRN, and output switch NOUT are OFF during internal-burst slot IBP. Backup power V_{BFP} releases power via current loop LOOP-DP in FIG. 11A to increase electromagnetic energy H that transformer TFAC stores. Internal-burst slot IBP is modulated to make internal-storage ISP merely appear or have a predetermined minimum duration.

FIG. 11B demonstrates current loop LOOP-MP that increases electromagnetic energy H of transformer TFAC during input slot INP of FIG. 10. Shown in FIG. 10, main switch MAIN is ON, but discharge switches NAP and NAN, secondary-side switches NSRP and NSRN, and output switch NOUT are OFF during input slot INP. Via current loop LOOP-MP, AC mains power VAC supplies power to increase electromagnetic energy H that transformer TFAC stores. Input slot INP is modulated by primary-side controller 602 to achieve PFC and to regulate backup power V_{BFN}. For example, the duration of input slot INP is modulated to make the shaded area under the waveform of winding current I_{PRM} in FIG. 10 within power transfer cycle TCYCP proportional to the present amplitude of AC mains power VAC times the length of power transfer cycle TCYCP, while the ratio is determined to regulate backup power V_{BFN}.

FIG. 11C demonstrates current loop LOOP-DOP which decreases electromagnetic energy H of transformer TFAC during output slot OTP of FIG. 10. Shown in FIG. 10, secondary-side switch NSRP and output switch NOUT are ON, but main switch MAIN, discharge switches NAP and NAN, and secondary-side switch NSRN are OFF during output slot OTP. During output slot OTP, electromagnetic energy H of transformer TFAC releases to supply power to output power source V_{OUT}. The length of output slot OTP is modulated by secondary-side controller 604 to regulate output power source V_{OUT}.

FIG. 11D demonstrates current loop LOOP-CP that decreases electromagnetic energy H of transformer TFAC during internal-storage ISP of FIG. 10. Shown in FIG. 10, discharge switch NAN and secondary-side switch NSRP are ON, but main switch MAIN, discharge switch NAP, secondary-side switch NSRN, and output switch NOUT are OFF during internal-storage slot ISP. Secondary-side switch NSRP could be turned OFF in another embodiment during internal-storage ISP, but the body diode of secondary-side switch NSRP will be positively biased anyway. Discharge switch NAN may be OFF during internal-storage ISP because the body diode of discharge switch NAN still can help to construct current loop LOOP-CP. During internal-storage slot ISP, electromagnetic energy H of transformer TFAC releases to supply power to backup power V_{BFN}.

The length of power transfer cycle TCYCP is controlled based on the load that output power source V_{OUT} supplies power to. For example, in response to output power source V_{OUT}, secondary-side controller 604 signals primary-side controller 602 whether the length of power transfer cycle TCYCP is appropriate, so primary-side controller 602 can accordingly modulate the duration of the next power transfer cycle.

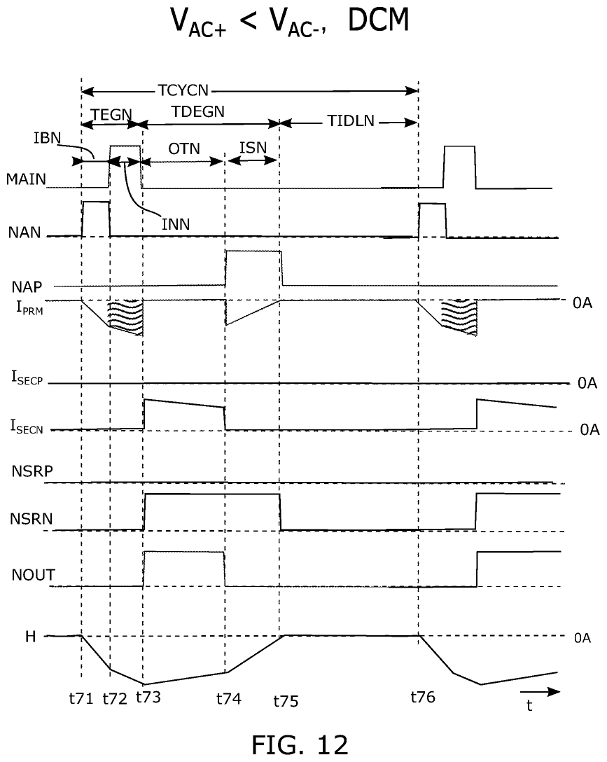

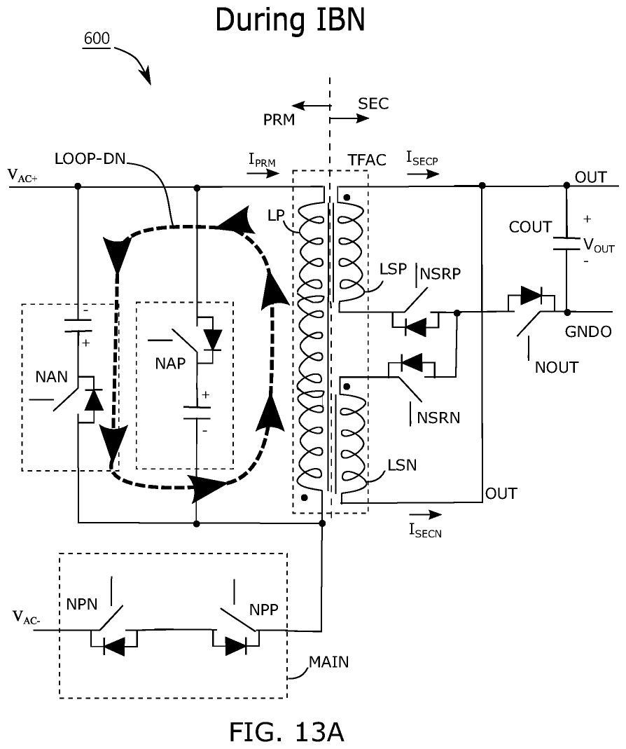

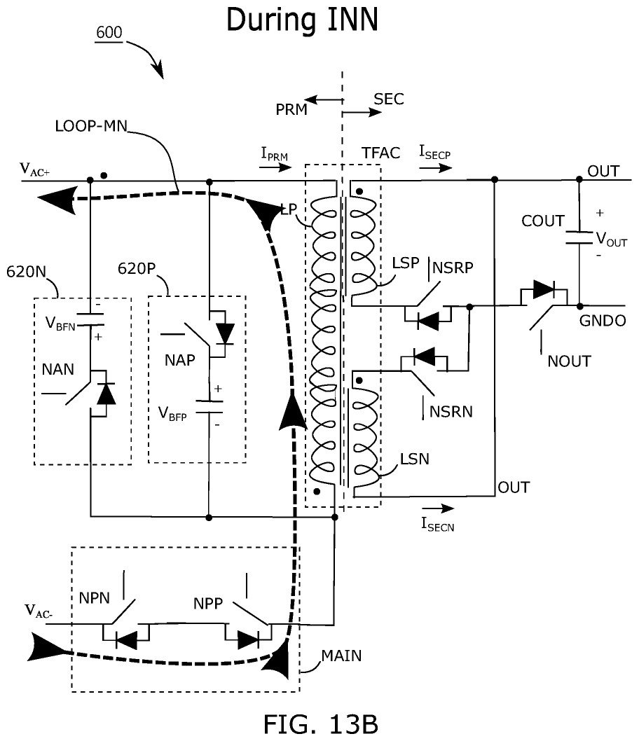

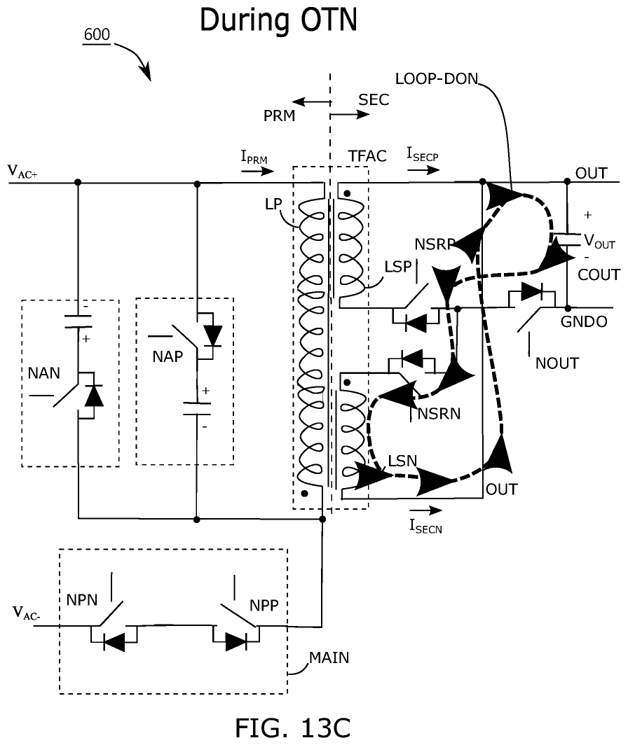

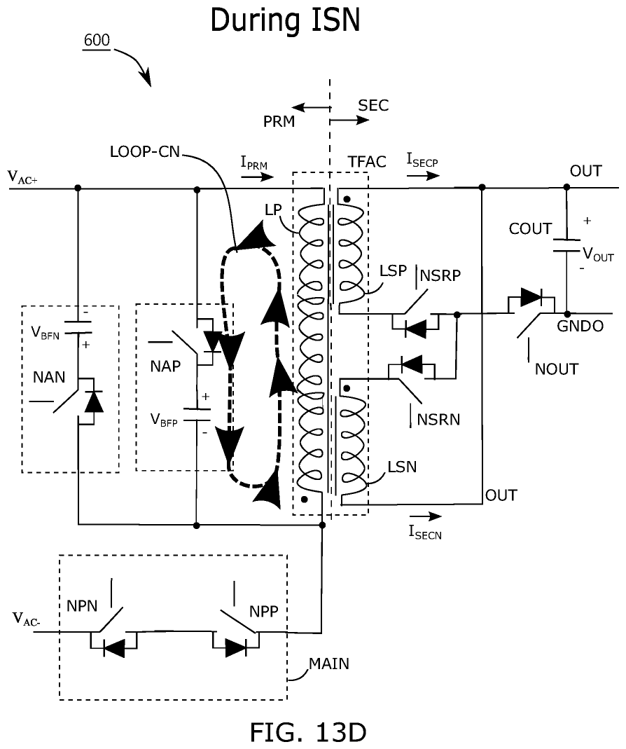

FIG. 12 demonstrates power transfer cycle TCYCN during a negative half period, and logic statuses and waveforms showing AC-to-DC bridgeless power supply 600 is operating in DCM. Power transfer cycle TCYCN has magnetization time TEGN with internal-burst slot IBN and input slot INN, demagnetization time TDEGN with output slot OTN and internal-storage slot ISN, and break time TIDLN. FIGS. 13A-13D demonstrate current loops LOOP-DN, LOOP-MN, LOOP-DON, and LOOP-CN respectively. FIGS. 12, 13A-13D correspond to FIGS. 10, 11A-11D respectively, while FIGS. 12, 13A-13D are for a negative half period and FIGS. 10, 11A-11D are for a positive half period. FIGS. 12, 13A-13D are comprehensible given the teaching regarding FIGS. 10, 11A-11D, so their explanation is omitted herein for brevity.

This invention is suitable not only for power supplies with galvanic isolation, but also for power supplies without galvanic isolation, such as boosters or buck-boosters.

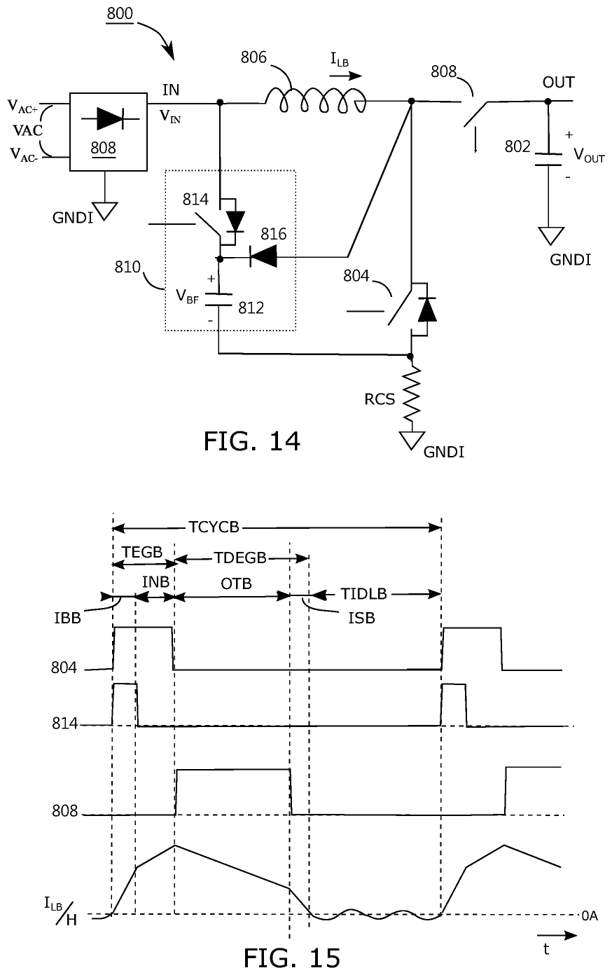

According to embodiments of the invention, FIG. 14 demonstrates AC-to-DC power supply 800, a booster with some modification basically. AC-to-DC power supply 800 in FIG. 14 is similar to the previously-disclosed power supplies, and the same or similar aspects therebetween might not be detailed because they are comprehensible given the previous teaching. FIG. 14 has bridge rectifier 808, inductor 806, backup circuit 810, main switch 804, current-sense resistor RCS, output switch 808 and output capacitor 802, the connection of which is shown in FIG. 14. Backup circuit 810 has discharge switch 814, backup power 812 and diode rectifier 816. Output switch 808 is a bidirectional switch, and could be composed of several switches.

FIG. 15 demonstrates power transfer cycle TCYCB, logic statuses and waveforms showing AC-to-DC power supply 800 is operating in DCM. From top to bottom, FIG. 15 has the waveforms representing the logic status of main switch 804, the logic status of discharge switch 814, the logic status of output switch 808, and winding current I_{LB} flowing through or electromagnetic energy H stored by inductor 806. Sequentially, power transfer cycle TCYCB has magnetization time TEGB with internal-burst slot IBB and input slot INB, demagnetization time TDEGB with output slot OTB and internal-storage slot ISB, and break time TIDLB. AC-to-DC power supply 800 operates in DCM as winding current I_{LB} or electromagnetic energy H drops to 0 A during power transfer cycle TCYCB. According to some embodiments of the invention, magnetization time TEGB may omit either internal-burst slot IBB or input slot INB, and/or demagnetization time TDEGB may omit either output slot OTP or internal-storage slot ISB. FIG. 15 is similar to FIG. 8 and is not further detailed herein as it is comprehensible given the previous teaching.

Embodiments of the invention have an AC-to-DC power supply that generates a power transfer cycle having a magnetization time with an internal-burst slot and an input slot, and a demagnetization time with an output slot and an internal-storage slot. During the input slot, an input power source increases the electromagnetic energy of an inductive device, to achieve PFC and to regulate a backup power. During the internal-burst slot, the backup power releases to increase the electromagnetic energy, making sure that the output power source can be well regulated. During the output slot, the electromagnetic energy releases to supply power to the output power source, and the output slot is modulated to regulate the output power source. The backup power stores the excess of the electromagnetic energy, if any, during the internal-storage slot. Accordingly, the AC-to-DC power supply could achieve PFC and output power regulation at the same time.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An AC-to-DC power supply for converting an input power source into an output power source, comprising:
an inductive device and a main switch connected in series between two input power lines coupled to the input power source;
a backup circuit providing a backup power; and
a power controller controlling the main switch and the backup circuit, to generate a power transfer cycle with an input slot, an internal-burst slot, and a demagnetization time;
wherein the main switch is turned ON and OFF only once within the power transfer cycle;
during the input slot, the power controller turns ON the main switch, and the input power source supplies power to the inductive device;
during the internal-burst slot, the power controller controls the backup circuit to let the backup power supply power to the inductive device; and
during the demagnetization time, the inductive device releases electromagnetic energy to supply power to the output power source.

2. The AC-to-DC power supply of claim 1, wherein the power transfer cycle includes a magnetization time, and the input slot follows the internal-burst slot within the magnetization time.

3. The AC-to-DC power supply of claim 1, wherein the demagnetization time includes an output slot and an internal-storage slot, the electromagnetic energy releases to supply power to the output power source during the output slot, and the electromagnetic energy releases to supply power to the backup power during the internal-storage slot.

4. The AC-to-DC power supply of claim 3, wherein the output slot is modulated to regulate the output power source, and the internal-burst slot is modulated in response to the internal-storage slot.

5. The AC-to-DC power supply of claim 1, wherein the backup circuit has a discharge switch and a capacitor providing the backup power, the discharge switch is turned ON during the internal-burst slot, and the discharge switch is turned OFF during the input slot.

6. The AC-to-DC power supply of claim 5, further comprising a current-sense resistor connected to the main switch via a current-sense node, and the capacitor is connected between the discharge switch and the current-sense node.

7. The AC-to-DC power supply of claim 1, wherein the power controller modulates the input slot to control PF of the power supply and to regulate the backup power.

8. The AC-to-DC power supply of claim 1, wherein the input power source is an AC mains power, the AC-to-DC power supply is a bridgeless power supply, the backup circuit is a first backup circuit providing a first backup power, the AC-to-DC power supply further includes a second backup circuit providing a second backup power, and the first and second backup power are used to supply power to the inductive device during a positive half period and a negative half period respectively.

9. The AC-to-DC power supply of claim 1, wherein the inductive device is a transformer providing galvanic isolation between a primary side and a second side, the backup circuit and the input power source are on the primary side, and the output power source is on the secondary side.

10. A control method in use of an AC-to-DC power supply converting an input power source into an output power source, wherein the AC-to-DC power supply has an inductive device, a main switch, and a backup circuit providing a backup power, the control method comprising:
turning ON and OFF the main switch only once during a power transfer cycle with an input slot, an internal-burst slot, an output slot and an internal storage slot;
turning ON the main switch during the input slot, so that the input power source supplies power to the inductive device during the input slot;
controlling the backup circuit to let the backup power supply power to the inductive device during the internal-burst slot;
releasing electromagnetic energy stored by the inductive device to supply power to the output power source during the output slot; and
releasing the electromagnetic energy to supply power to the backup power instead of the output power source during the internal-storage slot.

11. The control method of claim 10, wherein the AC-to-DC power supply is a flyback power converter.

12. The control method of claim 11, wherein the internal-burst slot precedes the input slot within the power transfer cycle.

13. The control method of claim 10, further comprising:
modulating the output slot to regulate the output power source; and
modulating the internal-burst slot in response to the internal-storage slot.

14. The control method of claim 10, comprising:
modulating the input slot to control PF of the AC-to-DC power supply and to regulate the backup power.

15. The control method of claim 10, wherein the backup circuit includes a discharge switch and a capacitor providing a backup power, the discharge switch is connected between the capacitor and an end of the inductive device, and the control method comprises:
turning ON the discharge switch during the internal-burst slot.

16. The control method of claim 10, wherein the backup circuit and the backup power are a first backup circuit and a first backup power respectively, the AC-to-DC power supply further has a second backup circuit providing a second backup power, the input power source is an AC mains power alternatively operating in a positive half period and a negative half period, and the control method comprises:
controlling the first backup circuit to let the first backup power supply power to the inductive device within the positive half period; and
controlling the second backup circuit to let the second backup power supply power to the inductive device within the negative half period.

17. A power controller in use of an AC-to-DC power supply converting an input power source into an output power source, wherein the AC-to-DC power supply has a main switch, an inductive device and a backup circuit with a discharge switch and a capacitor providing a backup power, comprising:
a power-factor controller controlling the main switch to control power factor of the AC-to-DC power supply and to regulate the backup power; and
a burst controller for turning ON the discharge switch so that the backup power supplies power to the inductive device;
wherein the main switch is turned ON and OFF only once during a power transfer cycle with an input slot and an internal-burst slot, the power-factor controller turns ON the main switch during the input slot, and the burst controller turns ON the discharge switch during the internal-burst slot.

18. The power controller of claim 17, wherein the power transfer cycle includes an output slot and an internal-storage slot, electromagnetic energy stored by the inductive device releases to supply power to the backup power during an internal-storage slot, and the burst controller modulates the internal-burst slot in response to the internal-storage slot.

19. The power controller of claim 17, wherein the internal-burst slot precedes the input slot within the power transfer cycle starting with the internal-burst slot.

20. The power controller of claim 17, wherein the AC-to-DC power supply provides a current-sense signal representing a current flowing through the inductive device, the inductive device includes a primary winding and an auxiliary winding, the power-factor controller controls the main switch in response to the current-sense signal and a winding voltage of the auxiliary winding.
